(19) United States
(12) Patent Application Publication
(10) Pub. No.: US 2006/0089933 A1
(43) Pub. Date: Apr. 27, 2006

(54) Networked broadcast file system

(75) Inventors: Rajesh Bhagwandas Khandelwal, Bridgewater, NJ (US); Dennis Bushmitch, Somerset, NJ (US); Alan Kaplan, Princeton, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/970,708

(22) Filed: Oct. 21, 2004

(51) Int. Cl. G06F 17/30

(52) U.S. Cl. 707/10

(57) ABSTRACT

The file system framework extends availability of current object carousel data, delivered via broadcast stream, to devices and services associated with a networked computer system. The networked computer system, which can be a home network that includes diverse networked home appliances, is made capable of hosting object carousel data in a seamless fashion. Devices and appliances mount and unmount the networked broadcast file system, just as they would any other data store on the network. Mechanisms are provided to refresh copies of the object carousel data. The data can include data files, streams and events. These data can be communicated to devices and appliances, upon request or as unicast, multicast or broadcast data streams. Events can be communicated across the network to cause selected actions to be initiated automatically.

### BACKGROUND OF THE INVENTION

The present invention relates generally to object carousels associated with digital transport streams. More particularly, the invention relates to a mechanism that extends the availability of object carousels in a broadcast stream to devices and services available on a home network or to users of a virtual private domain (e.g., connected via the Internet).

Digital television (DTV) is implemented upon a set of standards that provide for the distribution of audio, video and data. As of this writing the MPEG standard is currently employed. Currently, broadcasters utilize the MPEG-2 standard to deliver motion pictures, audio and digital data, including executable application data, to subscribers and/or members of the public. In this regard, although the MPEG-2 standard is in current use, the inventions discussed herein are not intended to be limited to such standard. Indeed, the inventions are adapted to evolve with evolving standards, allowing the inventions to be exploited both today and in the future.

Television viewers are, of course, aware that digital television will allow audio and video content to be delivered for enjoyment in the home. What many may not realize, however, is that the DTV standards also define data storage, retrieval and broadcasting services whereby digital information other than the audio and video content may be delivered to the home. By way of example, when it is necessary to upgrade the software in the home user's DTV receiver or set-top box, one or more files containing the digital information needed to perform the upgrade may be transmitted as part of the MPEG transport stream (according to the DTV standards) to the receiver or set-top box. In some instances, this digital data may represent an executable program that is then launched and run on the local receiver or set-top box to effect the software upgrade.

The MPEG-2 standard, for example, provides a full set of protocols known as the digital storage medium command and control (DSM-CC) protocols that may be used to control the flow of this digital information between the video source and the receiving equipment. According to the roadmap outlined by the DSM-CC standards, after an initial link has been set up between two entities in a video delivery network (such as between the broadcast source and the user's receiver or set-top box) DSM-CC provides the functionality to continue the setup of an application session. Because this session setup happens at the interface between the network and the user equipment, DSM-CC defines a user-to-network protocol. Once the application session has been set up, further logical links are established between the video server and the receiver or set-top box. One logical link might be used for user data (like MPEG-2 coded video) and another logical link might be used to control what is happening on the user data link. This latter link is sometimes called the control link.

The actual protocol to be used on this control link is not specified by DSM-CC. However, DSM-CC defines a set of services (such as services to manipulate a video stream) in the server. These services can be used by the client on the receiver or set-top box. Because these services are primarily relevant between two user entities (such as the server and the client), the DSM-CC standard refers to them as the DSM-CC user-to-user interface (U-U interface). Thus the DSM-CC standards envision two fundamentally different interfaces, a user-network interface and a user-user interface. The user-network interface is used primarily for session setup and teardown and for managing the resources needed for the session. The user-user interface provides more application layer-oriented functions. For example, the user-user interface is used for application download communications and client-server communications.

Application Download Communication

Under the DSM-CC protocol, the user-user interface enables application download operations, which are primarily used for loading executable code from the server to a client. In a service on demand scenario, for example, a navigator application software program might be downloaded immediately after the session between the server and the client is set up. For such relatively straightforward download communication, the DSM-CC defines a simple message-based protocol, which implements a basic data flow-control mechanism.

There are, however, some applications where the simple data flow-control mechanism may not be sufficient. The DSM-CC thus provides for the use of a broadcasting approach to downloading digital data such as executable code from the server to a plurality of end users. To support broadcast download, the DSM-CC employs a data carousel which mediates the downloading of data. The data carousel supplies data continuously on a well defined download channel. Clients can tune to this channel, identify the data that is provided for download by analyzing periodically transmitted download control messages, and finally capturing the data the clients are interested in.

Client-Server Communication

After a session has been set up between the client and the server, the actual software application used to implement the service can then be started. Typically the service will employ one software component executed on the client and another software component on the server. Frequently the client software provides a user interface that will allow the user to navigate and use the actual service.

The client-server communication needed to support the software application during use is typically quite application-specific. For example, to implement VCR functionality in an interactive video on demand application, commands like fast forward, rewind or pause will typically be transmitted from the client to the server. These commands would be implemented using the user-user portion of the DSM-CC protocols.

User-User Object Carousel

The data carousel protocol makes use of non-flow-controlled download messages to provide periodic broadcast of data to a set of clients. While simple images may be distributed using the generic data carousel services, a more ambitious use of data carousel services is to provide an environment where the actual user-user objects behind a user service are physically delivered to clients. To support this type of functionality, DSM-CC specifies a user-user (U-U) object carousel and a broadcast interoperability protocol (BIOP). BIOP provides a standard way of embedding in broadcast carousels object references that describe actual locations of object representations within the same broadcast channel. U-U objects may include such objects such as directories, files, streams and service gateways.

Object carousels thus represent a form of file system that may be present in a digital transport stream. Object carousels provide mechanisms to deliver files, streams, events and applications to a digital receiver. The digital receiver mounts the object carousel when a user tunes to a particular channel, and unmounts the object carousel when that channel is tuned away. Currently the data delivered via the object carousel is targeted for the digital receiver itself. There exists no framework to extend the availability of this data to appliances or devices in a home network, for example.

### SUMMARY OF THE INVENTION

The present invention provides a mechanism to extend the availability of the object carousel, present in a digital transport stream such as a broadcast stream, to devices and services in a home network or to a user's virtual private domain (connected via the Internet, for example). Among the advantages offered by the proposed mechanism is that broadcasters can deliver content to devices that are not generally able to use information on the broadcast stream. Such devices include a wide variety of home appliances and networked devices. The innovation allows content authors to create applications and content for home appliances, thus extending the reach of those authors' creations beyond the digital TV receiver, itself. The innovation provides appliances with access to content via a proxy or pseudo-connection to the broadcast pipe (broadcast stream).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a first embodiment of the networked broadcast file system;

FIG. 2 illustrates different forms of content that are available through the broadcast file system of FIG. 1;

FIG. 3 is an interaction diagram useful in understanding how the networked broadcast file system utilizes information provided by the object carousel, including sending requests to refresh that information;

FIG. 4 illustrates how the information received from object carousels can be represented as a series of timed events that cause associated appliances to perform various functions at programmed times;

FIG. 5 illustrates that the streaming data provided by the networked broadcast file system can be disseminated in a variety of ways, including unicast, multicast and broadcast;

FIG. 6 illustrates that the networked broadcast file system supports a distributed architecture;

FIG. 7 is a first architectural diagram illustrating an exemplary deployment of the networked broadcast file system; and

FIG. 8 is a second architectural diagram illustrating a second exemplary employment of the networked broadcast file system which uses a proxy technique.

### DETAILED DESCRIPTION OF THE PREFERRED EMBODIMENTS

The following description of the preferred embodiment(s) is merely exemplary in nature and is in no way intended to limit the invention, its application, or uses.

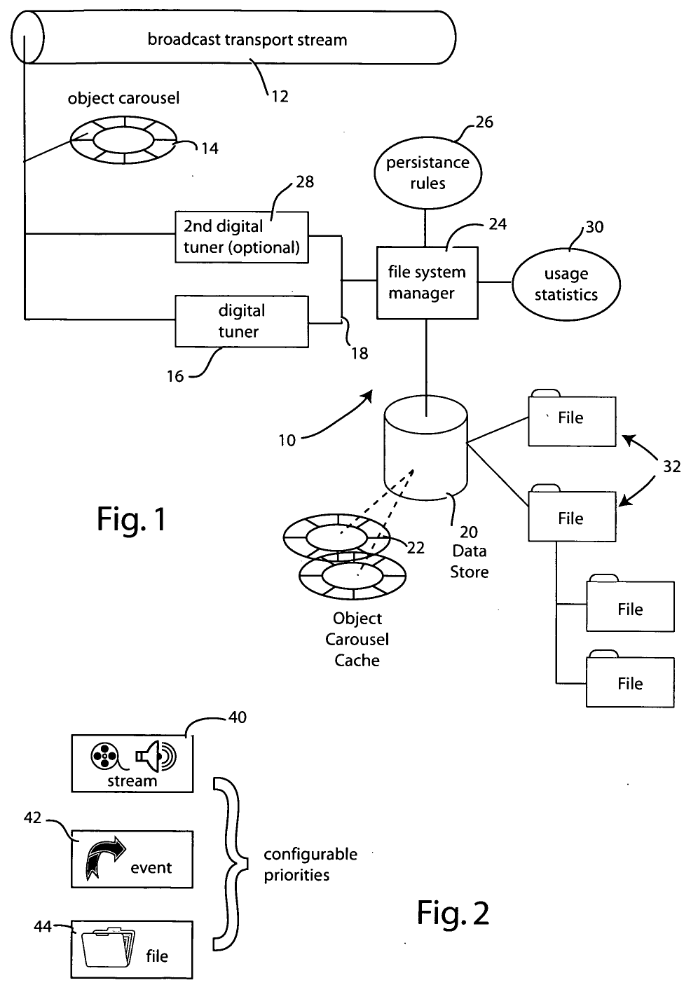

Referring to FIG. 1, the networked broadcast file system is illustrated generally at 10. The system is designed to cache snapshots of the object carousel present in the digital transport stream and to apply various data persistency rules in order to build a number of different file system images, as desired. Thus, in FIG. 1, the broadcast transport stream is illustrated at 12, with an exemplary object carousel 14 present in the transport stream thereof. A digital tuner 16 receives the object carousel in the usual fashion. Ordinarily, the digital tuner, itself, consumes the data delivered via the object carousel. Thus, for example, data in the object carousel might be conventionally used to upgrade the operating system software of a digital cable box, for example.

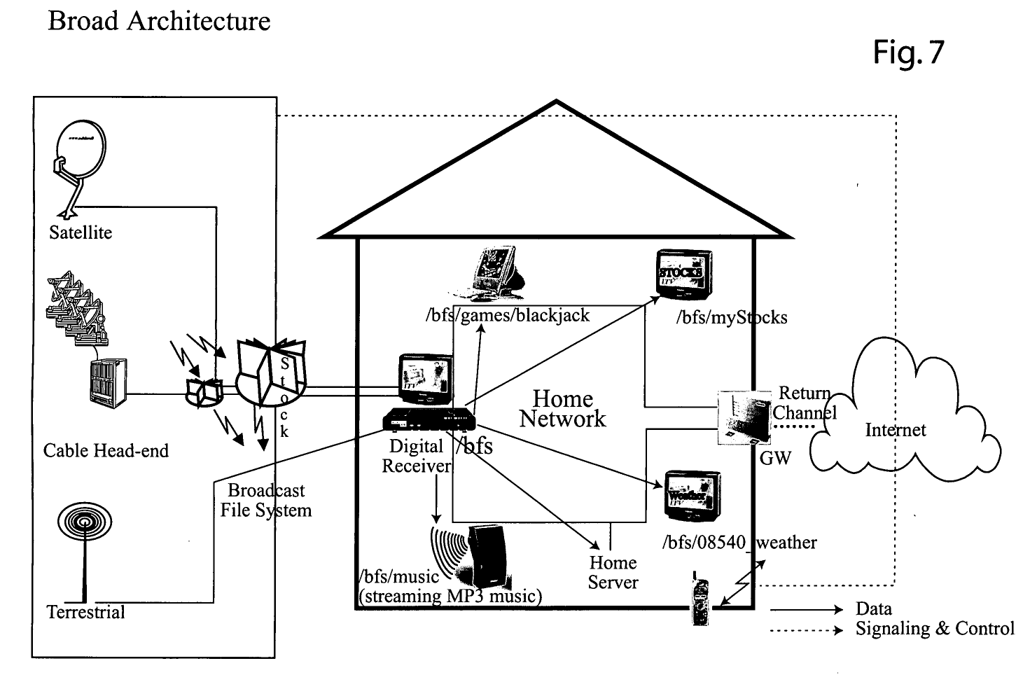

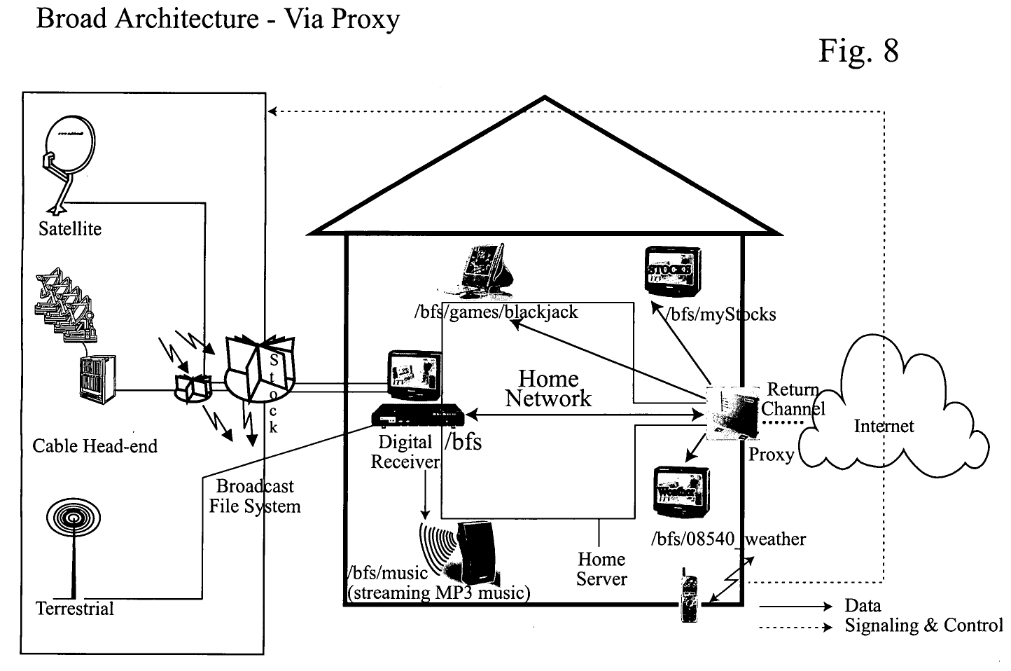

The present invention provides additional file system services as an extension of or attachment to the digital receiver or tuner, as at 18. This extension makes the object carousel 14 available to devices on a local area network, such as a home network, that may not be designed to directly consume object carousel data as a digital receiver would. The file system 10 includes a data store 20 where one or more snapshots of the object carousel may be cached as illustrated at 22. As will be later illustrated in connection with FIGS. 7 and 8, the data store 20 can be associated with any hardware component or appliance accessible to the local network (e.g., home network). Thus the networked broadcast file system 10 can be hosted by the digital receiver 18, or by any other device or appliance (or collection of devices and appliances) on the local area network.

The networked broadcast file system organizes the cached object carousel data in a manner native to the local area network or home network with which the system is associated. Thus the networked broadcast file system presents data in data store 20 as a collection of files in accordance with the protocols of the networked computer system with which it is associated. This allows devices on the network to access and use the data, even though those devices may not be natively able to consume data from the object carousel.

The data store 20 is mediated by a framework of function-providing objects represented generally in FIG. 1 by the block identified as file system manager 24. Just as the data store can reside on any one or more of the devices or appliances on the network, the functionality provided by the file system manager 24 can likewise be hosted on or distributed across one or more devices or appliances on the network, or on the digital receiver. The file system manager 24 implements a set of persistence rules 26 that govern how the cached snapshots of the object carousel may be kept up to date. In one embodiment, the file system manager 24 has access to a second digital tuner 28 and is able to utilize that tuner to select a desired broadcast channel for receiving additional or updated object carousel data.

The file system manager 24 further employs a data store of usage statistics 30. Thus the file system manager 24 may be configured to store usage statistics such as frequency of tuning and persistency duration in order to mediate how object carousel data is kept up to date.

While a second digital tuner 28 is beneficial, it is not required. The file system manager 24 can also be configured to control the first digital tuner 16 in order to keep the object carousel data current. This may be done, for example, when the digital tuner 16 is in standby mode. The file system manager can force-tune the digital tuner 16 in order to deliver data from a live object carousel to a user or service who has requested it.

The file system manager 24 is preferably configured to present the information obtained from the object carousel as a file system that can be used according to standard network file access protocols. An exemplary file system is illustrated at 32 in FIG. 1. Because the file system 32 is configured to conform to standard file system protocols, devices on the network do not need any special information in order to access data stored therein. Applications running on the network can simply mount the appropriate data store and have normal access to the files represented therein. In addition to supporting standard file system data access commands, the networked broadcast file system may provide its own command set of operations to augment those normally found in a file system. An example command set is illustrated in Table I below.

TABLE I
NBFS Example Command Set

```
Server lookup - (broadcast query)
dir (module) list
file list
open
    synchronous
    asynchronous
    pipe mode (streaming)
close
read
    blocking
    non-blocking
    push/pull model
stat
mount
umount
refresh
Force tune
Status - mounted or cached
Event/Trigger registration & notification
    Subscription-based or broadcast
    based on meta-data for filtering
    tuned-away event
    end-of-file
    version update
    carousel events (events in the OC)
    application specific data payload wrapped in events or triggers
```

Although FIG. 1 has illustrated the file system 32 as a collection of standard data files, the networked broadcast file system is not restricted to data files. On the contrary, as illustrated in FIG. 2, the networked broadcast file system 10 supports different forms of information, including streaming data 40, event data 42 and regular file data 44. If desired, these different forms of data may be organized hierarchically, with configurable priorities. Thus events 42 might be given highest priority, streams middle priority and files lowest priority.

In one exemplary embodiment, the network broadcast file system may only store snapshots of the directory structure as opposed the underlying data for each file in the directory structure. Upon request for a particular file, the file system manager grabs the object carousel data corresponding to the file from the object carousel. If the primary tuner is tuned to a different channel, it is envisioned that an available secondary tuner may be used to retrieve the object carousel data.

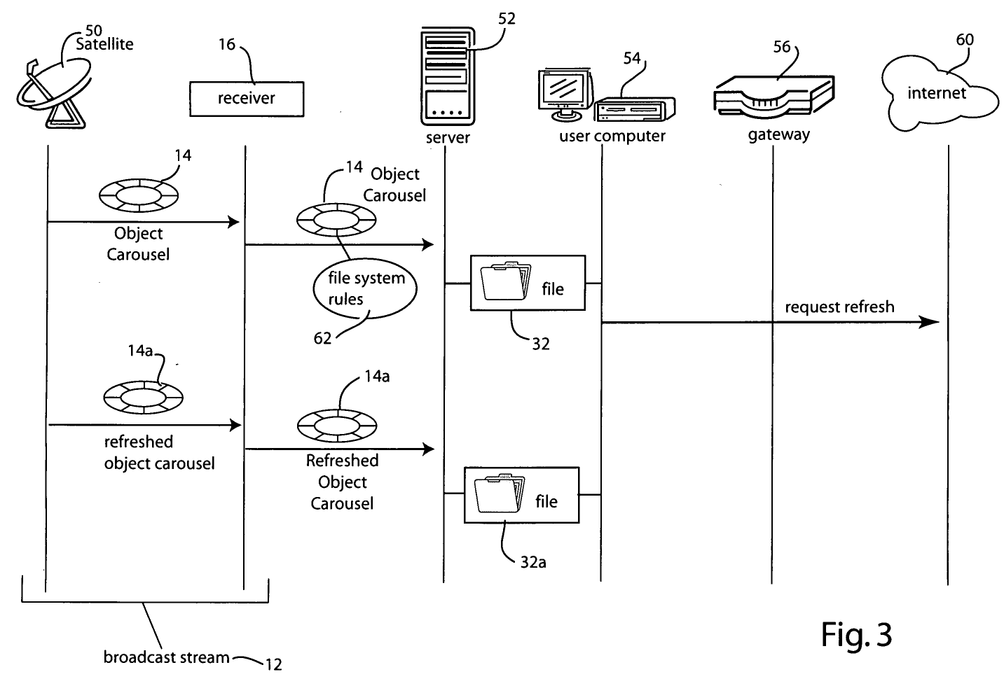

Referring to FIG. 3, some additional capabilities of the networked broadcast file system will now be described. FIG. 3 shows a digital tuner or digital receiver 16 positioned to receive object carousels 14 from a broadcast stream 12. In the illustration, the broadcast stream is supplied by a satellite dish 50. It will, of course, be understood that a broadcast data stream can be sent via other distribution technologies including cable and terrestrial broadcast.

The object carousel 14 is received by receiver 16 and the data therein is then sent to a suitable computer-such as server 52. The server 52 then makes the file system 32 available to other devices on the network, including the illustrated user computer 54. The network may also include a gateway or router 56 to allow devices on the network (such as server 52 and user computer 54) to communicate with the Internet 60.

The networked broadcast file system is preferably configured to support a set of predefined file system rules. These rules can either be included as rules stored by the file system manager 24 (FIG. 1) or they may be provided as file system rules 62 with the object carousel 14. The file system rules may include file system user access privileges. Thus access privileges may be broadcast in the object carousel 14 and then propagated to the file system 32. The file system manager 24 (FIG. 1) sets the access privileges of the various streams, events and files by setting attributes within the file system's access control system. Thus certain users may be restricted from accessing certain information within the file system. These access privileges can be overridden by an authoritative user, if desired. Also, depending on the configuration, a user may request exclusive access to a certain file within the file system. This would be granted by setting privileges so that only that user could gain access to the restricted file.

Because file system rules 62 may be delivered via the object carousel 14, the carousel can deliver access models to the receiver 16, which are in turn carried out by the networked broadcast file system. This facility allows, for example a file system mount or unmount operation to be initiated from the broadcast side (i.e., via the broadcast stream 12).

Alternatively, a user of the file system 32 can initiate a refresh of the file system data. This can be accomplished, as illustrated in FIG. 3, by sending a request to refresh via the Internet 60. In this case, the Internet serves as a return channel or back channel whereby the request refresh message is sent to the broadcast side. In response, a refreshed object carousel may be sent as illustrated at 14a, with the information being used to refresh the file system as illustrated at 32a. While the Internet 60 may be used as a return channel or back channel, some systems may provide a return channel or back channel in the receiver 16. If such is provided, the request to refresh message may be sent to the broadcast side via this route, as well.

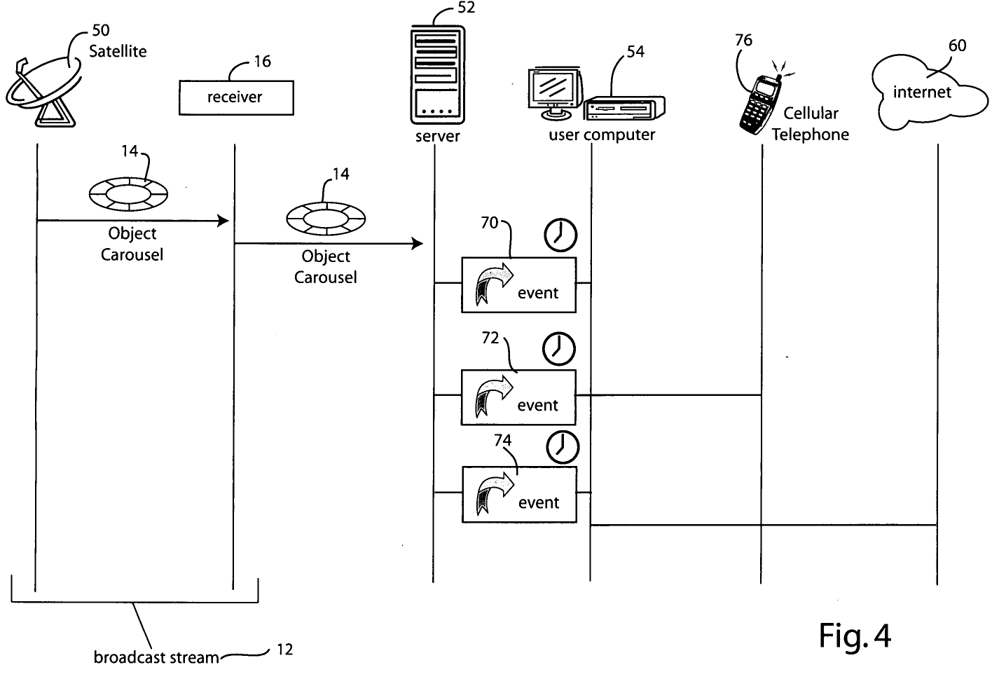

Referring now to FIG. 4, it is seen that the object carousel 14 may represent a series of timed file system events. In FIG. 4 events 70, 72 and 74 have been illustrated. Alternatively, a pattern of file system events can be used to construct an object carousel representation for distribution to other entities. In the example shown in FIG. 4, events 70 and 74 are utilized or subscribed to by the user computer 54. Event 72 is utilized by a different device on the network, in this case a cellular telephone 76. In both cases, if desired, the events received by the respective user devices can serve to trigger further actions. In the case of user computer 54, event 74 (or the combination of events 70 and 74) might cause the user computer to perform a specified operation involving the Internet 60. Similarly, event 72 might cause the cellular telephone 76 to perform a prespecified operation, such as placing a call to a given number. This call could be initiated for a variety of different reasons, including but not limited to, sending a notification to the owner of the cellular phone or to a third party, and communicating with a service provider to request a cellular download of updated features or updated operating system modules.

Objects delivered by the file system can thus be controlled in the manner that they are made available to the mount points (time, browsing order, content availability, and the like). This capability enables a number of different useful functions. For example, a low priority subscriber might be configured to receive no events, whereas a medium priority subscriber might receive a list of four events in the directory, with the ability to access only two of those. A high priority subscriber might receive all events, with full ability to access the events in the directory structure. Event timing information can also be utilized to cause event objects to appear and disappear without necessarily requiring parallel changes in the object carousel data itself.

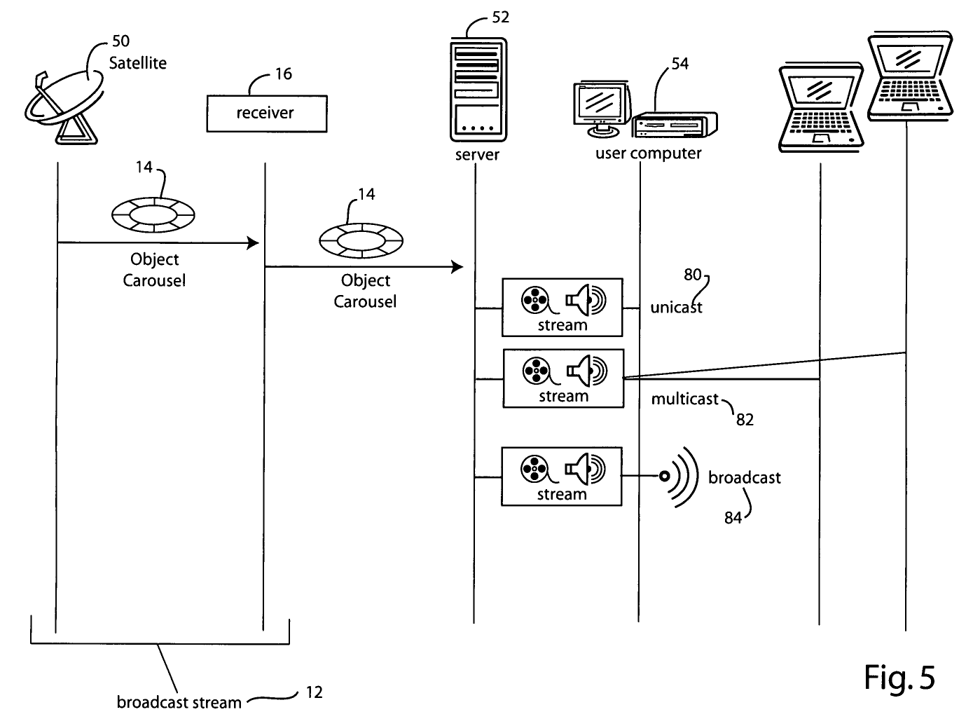

As shown in FIG. 5, the networked broadcast file system can supply data to users via a variety of different mechanisms including unicast (shown at 80), multicast (shown at 82) and broadcast (shown at 84).

The persistence rules 26 (FIG. 1) may be invoked to maintain control over the unicast, multicast and broadcast data distributions. Cached file systems can be discarded, for example, when a time-to-live timer expires and the file system is not being used. If the file system is being used and a new version is detected, a “version update” event may be dispatched to subscribers. The subscribers could then elect whether to install the version update immediately, or wait until a more convenient time. If desired, however, certain version updates may be flagged as mandatory. Such version updates would be installed without requiring election by the subscribers. Thanks to the flexible design, the networked broadcast file system supports an eventing mechanism whereby clients can subscribe to certain events (such as tune-in/tune-away events and version update events) and then take appropriate action when such subscribed to events are triggered.

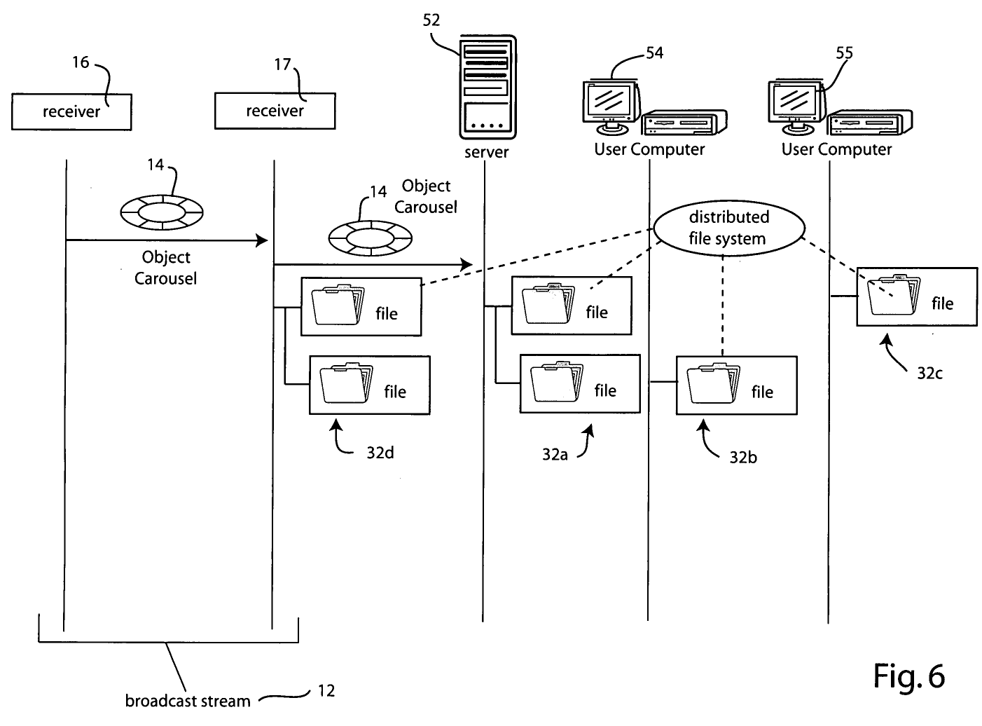

The networked broadcast file system may be either deployed in a single device or it may be distributed among various devices on the network. FIG. 6 illustrates how a distributed file system might be implemented. Portions of the file system at 32a may be deployed on server 52 while additional portions 32b and 32c are deployed on user computers 54 and 55, respectively. In addition, the file system may be distributed among various receivers on the network. Illustrative of this technique are receivers 16 and 17. Thin clients can read, write and/or access contents from and to the thick clients. Thin clients with storage can collaborate and form a distributed file system for efficiency. Tuners on distributed devices (thin clients) can be used transparently to grab the latest snapshots from the broadcast stream.

The networked broadcast file system, in concept, does not care what transport mechanism or underlying physical networking technology is used in the implementation. Moreover, the file system services can be implemented either in the digital receiver or in a suitable proxy device. To illustrate, refer now to FIGS. 7 and 8. In FIG. 7 the digital receiver 16 hosts the file system services. In FIG. 8, a proxy device hosts that file system services. In FIG. 8, the home network gateway device 56 is used as the proxy device. Of course, other devices may also be used to perform the proxy function. FIGS. 3-6 presented several examples, where the file services were provided, at least in part, on other devices and appliances on the network, including servers, user computers, portable devices, home appliances, and the like.

Once the networked broadcast file system is implemented, it opens up a number of different useful possibilities. For example, digital audio (or digital video) may be streamed in a convenient device on the network. Thus a user could tap into an MP3 audio stream and listen to it on any suitable device having audio playback capabilities. The networked broadcast file service could also be used to provide software upgrades of devices on the home network, delivered via the object carousel. Continuous stock and weather information might also be delivered to selected home appliances that have network capability. The file system also supports convenient storage of streamed media in a home server. Thus object carousel-delivered streaming video or audio might be stored on a home server for later replay at a convenient time of the user's selection. Applications may also be delivered to home appliances. Essentially, the networked broadcast file system provides a powerful way to integrate object carousel data with a networked file system architecture. By organizing cached copies of the object carousel into a fully-functioning file system, numerous other networked devices are given easy access to object carousel information that previously could only be consumed by the digital tuner or receiver.

The networked broadcast file system can also be readily extended to serve as a universal plug and play (UPnP) service enabler. The file system provides the basic building blocks for creating UPnP object carousel service. Networked broadcast file system events and carousel events can be mapped to UPnP events. The file system command set can likewise be mapped to UPnP controls. Finally, the file system server lookup query can be used for discovery. This makes it possible to implement UPnP services including UPnP streaming services, and the like.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A network broadcast file system comprising:
a tuner coupled to tune a broadcast transport stream and thereby receive object carousel data;
a data store for storing a copy of said object carousel data;
a file system manager associated with said data store for presenting said stored copy of said object carousel data as a collection of files in accordance with the protocols of a networked computer system.

2. The networked broadcast file system of claim 1 wherein said file system manager maintains a set of persistence rules governing the storage of said stored copy of said object carousel data.

3. The networked broadcast file system of claim 1 wherein said file system manager maintains a set of usage statistics used in governing the storage of said stored copy of said object carousel data.

4. The networked broadcast file system of claim 1 further comprising second tuner coupled to tune a broadcast transport stream and thereby receive object carousel data.

5. The networked broadcast file system of claim 1 wherein said file system manager controls the tuner to selectively control the receipt of object carousel data.

6. The networked broadcast file system of claim 1 wherein said file system manager associates metadata with said collection of files to thereby classify said files into different file types.

7. The networked broadcast file system of claim 6 wherein said different file types are selected from the group consisting of streams, events and data files.

8. The networked broadcast file system of claim 6 wherein said different file types are organized by priority.

9. The networked broadcast file system of claim 6 wherein said different file types are organized by configurable priority.

10. The networked broadcast file system of claim 1 wherein said file system manager associates metadata with said collection of files to thereby classify said files according to access privilege.

11. The networked broadcast file system of claim 1 wherein said file system manager is configured to acquire file system rules from said object carousel.

12. The networked broadcast file system of claim 1 further comprising user device coupled by mounting said broadcast file system and being configured to request a refresh of object carousel data from said broadcast transport stream.

13. The networked broadcast file system of claim 12 wherein said user device requests refresh via a backchannel communication with an object carousel source.

14. The networked broadcast file system of claim 12 wherein said backchannel communication travels over the Internet.

15. The networked broadcast file system of claim 12 wherein said backchannel communication is effected by the tuner.

16. The networked broadcast file system of claim 1 wherein said file system manager is configured to mediate event messages associated with said stored copy of said object carousel data.

17. The networked broadcast file system of claim 1 wherein said file system manager is instantiated on at least one device coupled to a networked computer system.

18. The networked broadcast file system of claim 1 wherein said file system manager is instantiated on the tuner.

19. The networked broadcast file system of claim 1 wherein said file system manager is configured to disseminate said stored copy of said object carousel data as streaming data and events or filesystem objects.

20. The networked broadcast file system of claim 1 wherein said file system manager is configured to disseminate said streaming data according to at least one of the following methods: unicast, multicast and broadcast.

21. The networked broadcast file system of claim 1 wherein the file system manager is configured to supply data from the collection of files to a network device associated with a home network.

22. The networked broadcast file system of claim 21 wherein the file system manager is further configured to supply data from the collection of files via the Internet to a network device residing in a remote home network.
